(19) United States
(12) Patent Application Publication
(10) Pub. No.: US 2024/0019555 A1
(43) Pub. Date: Jan. 18, 2024

(54) METHOD AND DEVICE FOR LASER DETECTION, AND COMPUTER-READABLE STORAGE MEDIUM

(71) Applicant: SUTENG INNOVATION TECHNOLOGY CO., LTD., Shenzhen (CN)

(72) Inventor: Shen JIANG, Shenzhen (CN)

(73) Assignee: SUTENG INNOVATION TECHNOLOGY CO., LTD., Shenzhen (CN)

(21) Appl. No.: 18/219,703

(22) Filed: Jul. 9, 2023

(30) Foreign Application Priority Data
Jul. 15, 2022 (CN) 202210832125.5

(51) Int. Cl. G01S 7/4861; G01S 7/48; G01S 7/481; G01S 7/484

(52) U.S. Cl. CPC G01S 7/4861; G01S 7/4808; G01S 7/4815; G01S 7/484

(57) ABSTRACT

The present application relates to a method and device for laser detection, and a non-transitory computer-readable storage medium. The method includes: emitting a secondary emergent laser in a current detection cycle; receiving and analyzing an echo laser corresponding to the secondary emergent laser to obtain a detection result; determining an operation mode of a primary emergent laser in a next detection cycle according to the detection result; and emitting the primary emergent laser in the next detection cycle according to the operation mode of the primary emergent laser.

### CROSS-REFERENCE TO RELATED APPLICATION

The present application claims the benefit of priority to Chinese Patent Application No. 202210832125.5, filed on Jul. 15, 2022, which is hereby incorporated by reference in its entirety.

### TECHNICAL FIELD

The present application relates to the field of LiDAR, and in particular, to a method and device for laser detection, and a computer-readable storage medium.

### BACKGROUND

A LiDAR consists of an emitting system, a receiving system, a scanning control system, and a data processing system. The LiDAR measures a distance by measuring a time difference between an emergent detection laser and a received echo laser, and has the advantages of high resolution, high sensitivity, strong anti-interference ability, and being independent of lighting conditions, etc. The LiDAR has been widely used in the fields of autonomous driving, logistics vehicle, robot, vehicle-road coordination, and public intelligent transportation.

Single Photon Avalanche Diode (SPAD) is often used in a LiDAR product due to its excellent optoelectronic conversion capability. However, a single-photon receiver is also more susceptible to stray light, especially in a coaxial optical path system where the stray light is more pronounced. The stray light directly leads to early saturation of the single-photon receiver, which cannot respond to the echo laser in the close-range detection, thus causing a near-field blind zone in the LiDAR.

### SUMMARY

The present application provides a method and device for laser detection, and a computer-readable storage medium, which can eliminate the interference of stray light and enhance the detection capability of a LiDAR.

A first aspect of the present application provides a method for laser detection, including:
emitting a secondary emergent laser in a current detection cycle;
receiving and analyzing an echo laser corresponding to the secondary emergent laser to obtain a detection result;
determining an operating mode of a primary emergent laser in a next detection cycle according to the detection result; and
emitting the primary emergent laser in the next detection cycle according to the operation mode.

A second aspect of the present application provides a device for laser detection, including:
a first emitting module, configured to emit a secondary emergent laser in a current detection cycle;
a first emitting module, configured to emit a secondary emergent laser at a current moment of a detection cycle;
an analyzing module, configured to receive and analyze an echo laser corresponding to the secondary emergent laser to obtain a detection result;
a determining module, configured to determine an operation mode of a primary emergent laser in a next detection cycle according to the detection result;
a second emitting module, configured to emit the primary emergent laser in the next detection cycle according to the operation mode.

A third aspect of the present application provides an electronic apparatus, including: a processor; and
a memory having executable codes stored thereon, where when executed by the processor, the executable codes cause the processor to execute the method as described above.

A fourth aspect of the present application provides a computer-readable storage medium having executable codes stored thereon. When executed by a processor of an electronic apparatus, the executable codes cause the processor to execute the method as described above.

Regarding the technical solution provided by the present application, a secondary emergent laser is first emitted in a detection cycle for detection. According to a detection result of the secondary emergent laser, an operation mode of a primary emergent laser in the next detection cycle is determined. The secondary emergent laser has a low emission power and can detect a near-field region first. Based on a detection result in the near-field region, the distribution of target objects in the near-field region can be known first, and then the mode of operation of the primary emergent laser can be determined. When the target objects are distributed in a farther region, the emission power of the primary emergent laser is increased to ensure the detection capability of LiDAR. When the target objects are distributed in a nearer region, the emission power of the primary emergent laser is reduced to reduce a near-field blind zone generated by stray light and avoid an unnecessary high-power emission, thus reducing the power consumption of a LiDAR and improving the safety of human eyes.

It should be understood that the above general descriptions and the following detailed descriptions are only exemplary and explanatory and impose no limitation on the present application.

### BRIEF DESCRIPTION OF DRAWINGS

Exemplary embodiments of the present application are described with reference to the accompanying drawings, to illustrate the above and other objectives, features, and advantages of the present application. In the exemplary embodiments of the present application, the same reference numerals generally represent the same components.

FIG. 1 is a flowchart of a method for laser detection provided in an embodiment of the present application; and

FIG. 2 is a schematic diagram of laser emission and an echo analysis region thereof provided in an embodiment of the present application;

FIG. 3 is a schematic diagram of the relationship between an echo waveform of a secondary emergent laser and a leading signal shape of the secondary emergent laser provided in an embodiment of the present application;

FIG. 4 is a schematic diagram of the relationship between an echo waveform of a secondary emergent laser and a leading signal shape of the secondary emergent laser provided in another embodiment of the present application;

FIG. 5 is a schematic diagram of the relationship between an echo waveform of a secondary emergent laser and a leading signal shape of the secondary emergent laser provided in another embodiment of the present application;

FIG. 6 is a schematic diagram of the structure of a device for laser detection provided in an embodiment of the present application;

FIG. 7 is a schematic diagram of the structure of an electronic apparatus provided in an embodiment of the present application;

FIG. 8 is a schematic diagram of a single photon waveform provided in an embodiment of the present application, which refers to a photocurrent signal waveform output by an avalanche effect and a quenching process after a single photon unit is excited;

FIG. 9 is a schematic diagram of superposition of photocurrent signals and preamble signals of a real reflected laser returning from a reflected target object at a close range to reach a receiver, provided in an embodiment of the present application; and

FIG. 10 is a schematic diagram of a saturation actual waveform of an output circuit of a back terminal of a receiver when a laser device is emitted at full power, provided in an embodiment of the present application.

### DETAILED DESCRIPTION

The following describes embodiments of the present application with reference to the accompanying drawings. Although the embodiments of the present application are shown in the accompanying drawings, it should be understood that the present application may be implemented in various forms and should not be limited by the embodiments illustrated herein. On the contrary, the embodiments are provided for better understanding of the present application and delivery of the scope of the present application to a person skilled in the art.

The terms used in the embodiments of the present application are merely for the purpose of illustrating embodiments, but are not intended to limit the present application. The singular forms of “a,” “the,” and “this” as used in the present application and the appended claims are also intended to include plural forms, unless the context clearly indicates otherwise. It should be further understood that the term “and/or” used in this specification refers to any combination of one or more of the associated items listed and all combinations thereof.

It should be understood that although the terms “first,” “second,” “third,” and the like are used to describe various types of information in the present application, the information should not be limited to these terms. The terms are only used to distinguish between information of the same type. For example, without departing from the scope of the present application, first information may also be referred to as second information, and similarly, second information may also be referred to as first information. Therefore, a feature with a determiner such as “first” or “second” may expressly or implicitly include one or more features. In the description of the present application, “a plurality of” means two or more, unless otherwise specifically defined.

Single Photon Avalanche Diode (SPAD) has a very high photoelectric detection capability and is often used in LiDAR. The excellent photoelectric conversion capability of a single photon receiver can enhance the ranging capability of the LiDAR. However, stray light generated by unintended reflections and scattering inside the LiDAR can enter the single-photon receiver via a received optical path and affect the reception of an echo laser by the single-photon receiver, especially in a coaxial optical path system. The reasons for a forgoing impact are analyzed as follows.

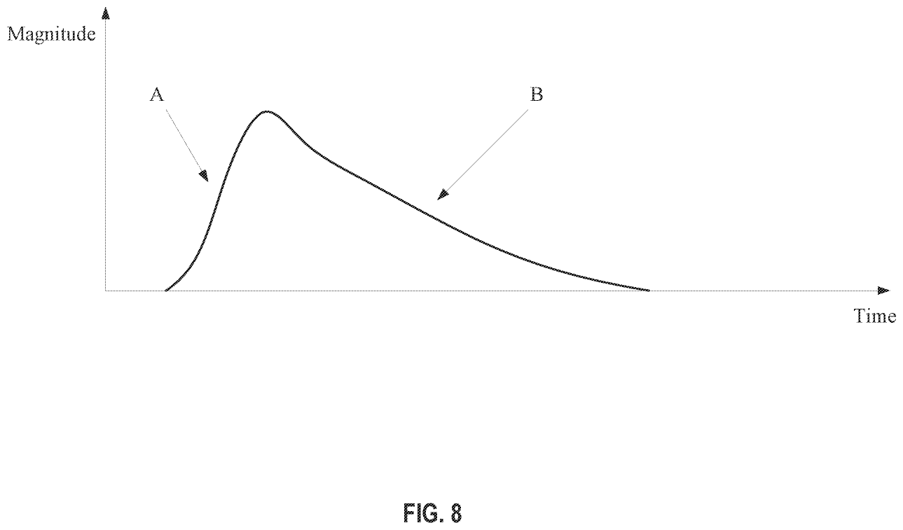

(1) An output waveform: a single photon waveform refers to a waveform of photocurrent signals output by an avalanche effect and a quenching process after the single photon unit is excited. Features thereof are shown in FIG. 8. A rising A-region shows a current change in a rapid avalanche. A falling B-region shows a process of current back to zero during the quenching process. The rising A-zone lasts very short time usually in an order of a hundred picoseconds. The quenching process is related to quenching resistance and junction capacitance inside a sensor and usually lasts for a few nanoseconds to tens of nanoseconds. The single-photon receiver usually consists of an array formed by a plurality of single-photon units. A waveform output by the single-photon receiver is the linear superposition of the single-photon waveforms. A waveform feature of the waveform is basically the same as that of the single-photon waveform.

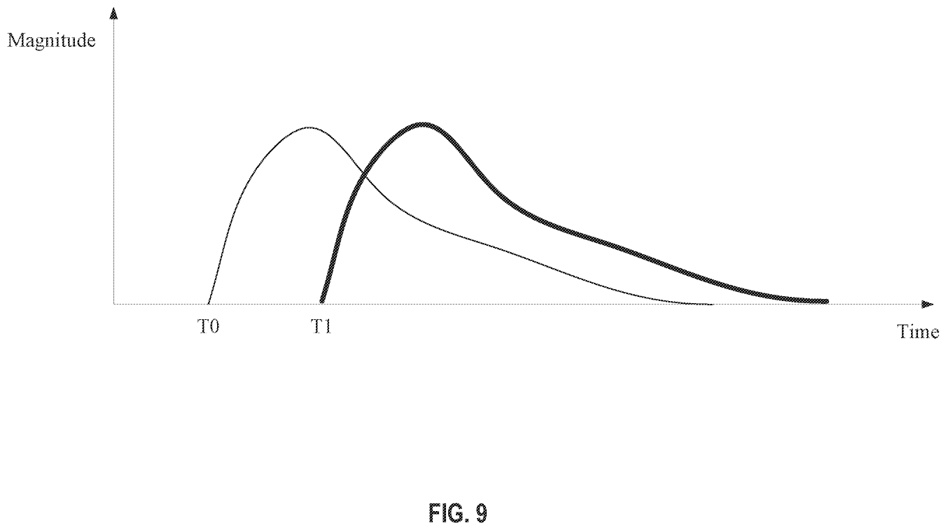

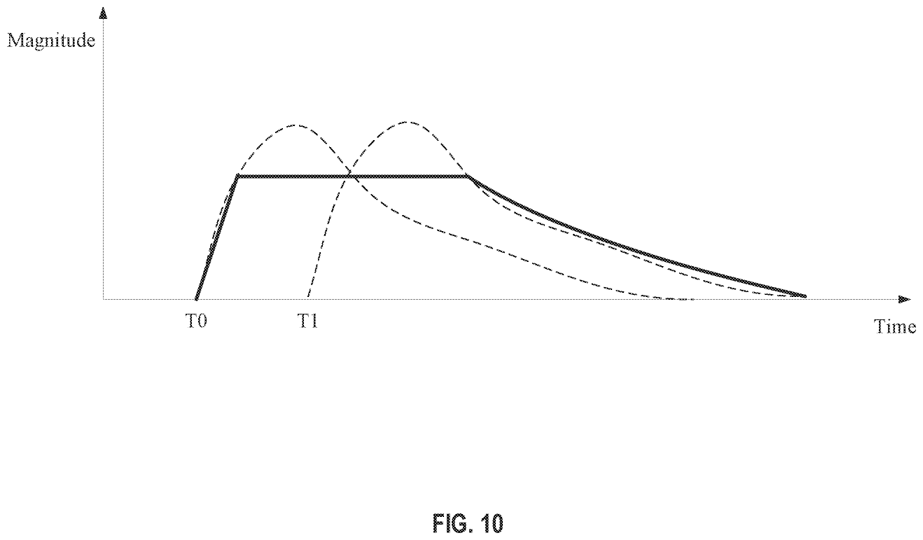

(2) In the coaxial optical path system, a small portion of the energy of an emergent laser emitted by the laser device directly passes through a stray path (i.e., the stray light) to reach the receiver. The receiver excites a certain number of single photon units after receiving the stray light, and outputs the photocurrent signals, i.e., preamble signals. As shown in FIG. 9, a real reflection laser returned from a reflected target object at a close range reaches the receiver faster. The photocurrent signals (reflected signals, as shown in a thick curve in the figure) of the real reflected laser are superimposed on the preamble signals (as shown in a thin curve in the figure) and cannot be identified, resulting in detection failure. When the LiDAR is operated, and when the laser device emits at full power, the stray light is enough to saturate an output circuit of a back terminal of the receiver. The actual waveform is shown as a solid line in FIG. 10. Real echo signals are indistinguishable.

The stray light directly leads to early saturation of a single photon receiver, which is unable to respond to the reflected laser detected at close range, thus creating a near-field blind region in the LiDAR.

In response to the above problems, embodiments of the present application provide a method for laser detection, which can eliminate the interference of stray light and improve the detection capability of LiDAR.

The technical solutions of embodiments of the present application are described in detail below in conjunction with the accompanying drawings.

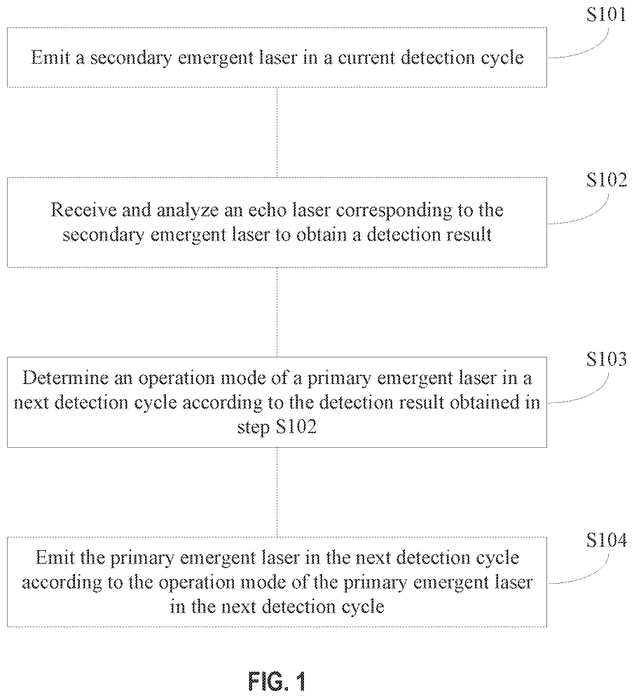

FIG. 1 shows a flowchart of the method for the laser detection shown in an embodiment of the present application, including steps S101 to S104 as follows.

Step S101: emitting a secondary emergent laser in a current detection cycle.

The detection cycle of a LiDAR includes a secondary emission cycle and a primary emission cycle. One secondary emergent laser is emitted and a corresponding secondary emergent echo laser is received in the secondary emission cycle. One primary emergent laser is also emitted and a corresponding primary emergent echo laser is received in the primary cycle. The detection result in the secondary emission cycle and the detection result in the primary emission cycle are spliced together to obtain one detection result covering a full-ranging scope. When a laser device emits an emergent laser, ranging begins. Then, a receiver is turned on in an operation state until the length of the time of an analysis region passes when the receiver is turned off. The length of the analysis region is greater than or equal to the flight time of emergent laser photons to and back from the farthest detection distance to ensure that photons returned from the farthest detection distance can be received. The higher the emission power of the emergent laser, the greater the farthest detection distance and the longer the corresponding analysis zone.

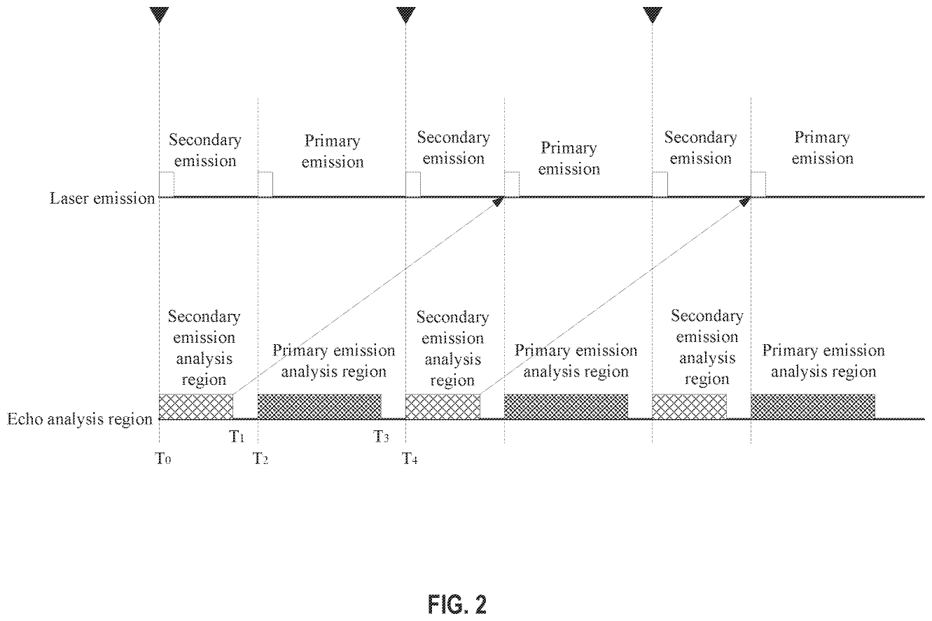

As shown in FIG. 2, TO is the emergent moment of the secondary emergent laser in the current detection cycle but also the beginning moment of a secondary emission analysis region. T1 is the cut-off moment of the secondary emission analysis region. T2 is the emission moment of the primary emergent laser in the detection cycle but also the beginning moment of a primary emission analysis region. T3 is the cut-off moment of the primary emission analysis region. T1 is less than or equal to T2. T4 is the emergent moment of the secondary emergent laser in the next detection cycle. T3 is less than or equal to T4.

The laser device emits the secondary emergent laser with a lower power to detect a near-field region. Due to the low power of the secondary emergent laser, the stray light caused by the secondary emergent laser has correspondingly a lower power. The receiver receives preamble signals output from the stray light of the secondary emergent laser. The preamble signals have a smaller waveform. The receiver recovers faster and causes a smaller near-field blind zone.

Step S102: receiving and analyzing the echo laser corresponding to the secondary emergent laser to obtain the detection result.

After receiving the echo laser of the secondary emergent laser, the receiver is photoelectrically converted to output echo signals corresponding to the secondary emergent laser. An output circuit of a back terminal amplifies, shapes, and samples the echo signals, and then outputs sampled signals. According to the sampled signals, the moment of receiving the echo laser is solved. The detection result of the target object, such as the distance between the laser device and the target object and other information, can be obtained.

In some embodiments, receiving and analyzing the echo laser corresponding to the secondary emergent laser to obtain the detection results can be achieved by steps S1021 to S1023, as illustrated below.

Step S1021: determining whether reflected signals in the echo signals are identified, where the echo signals are electrical signals output by a receiver after the echo laser is received. The reflected signals are electrical signals output by the receiver after the reflected laser is received. The reflected laser is a returned laser which is the secondary emergent laser reflected by the target object.

As mentioned earlier, when there is the target object within the farthest detection distance of the secondary emergent laser, the receiver of the LiDAR receives the echo laser, the echo laser includes a reflected laser and stray light returned after the secondary emergent laser is reflected by the target object, and then outputs the corresponding reflected signals and the preamble signals. Therefore, the echo signals output from the secondary emission cycle includes the reflected signals and the preamble signals. When the target object is located within a near-field blind zone of the secondary emergent laser of the LiDAR, the reflected laser returns faster. The reflected signals and the preamble signals are superposed together to output one waveform. The output circuit of the back terminal cannot distinguish between a reflected signal part and a leading signal part in one waveform. When the target object is located within the effective ranging scope of the secondary emergent laser of the LiDAR, for example, 2-20 m, the receiver outputs two non-superposed waveforms, that is, the reflected signals and the preamble signals, respectively. The output circuit of the back terminal can distinguish that there are two waveforms. On one hand, when there is no target object within the farthest detection distance of the secondary emergent laser, i.e., the distance of the target object is beyond the detection capability of the secondary emission cycle, because the reflected laser is too weak for the receiver to respond, no reflected signals is output. There is only one leading signal in the echo signals.

From the above analysis, it can be seen that there are two cases of the echo signals output from the secondary emission cycle, which outputs one waveform and two waveforms, respectively. Therefore, it is first possible to determine whether the reflected signals in the reflected laser is identified according to the number of waveforms of the echo signals that can be successfully sampled by the output circuit of the back terminal. In some embodiments, when the output circuit of the back terminal can sample two waveforms in the secondary emission analysis region, that is, the preamble signals and the reflected signals of the secondary emergent laser, the reflected signals can be identified. When the output circuit of the back terminal only can sample one waveform in the secondary emission analysis region, the waveform may be the reflected signals and the preamble signals that are both superposed, or may be the preamble signals only.

Step S1022: when the reflected signals are not identified, the detection result is determined according to the waveform feature of the preamble signals of the secondary emergent laser.

It is clear from the foregoing that when the reflected signals are not identified, there are two situations: first, the receiver receives the reflected laser of the secondary emergent laser. However, the reflected signals and the preamble signals that are both output by the receiver are superposed. The output circuit of the back terminal cannot distinguish the reflected signals of the secondary emergent laser. Second, the target object is beyond a ranging scope. The receiver really does not receive the reflected laser of the secondary emergent laser. The receiver does not output the reflected signals but only the preamble signals.

In some embodiments, according to the waveform feature of the preamble signals of the secondary emergent laser, determining the detection result may be as follows: obtaining a feature difference value of the waveform feature of the preamble signals and a preset waveform feature, comparing the feature difference value with a preset threshold; when the absolute value of the feature difference value exceeds the preset threshold, determining that the moment of receiving the reflected laser is earlier than a first preset moment; when the absolute value of the feature difference value is less than or equal to the preset threshold, determining that the reflected laser is not received.

In some embodiments, the preset waveform feature can be obtained by calibrating the preamble signals of the LiDAR. When no reflected signals are identified, it may be that the preamble signals and the reflected signals are superposed, or that only the preamble signals are available. Therefore, by comparing the received preamble signals with the waveform feature of the preamble signals obtained by advance calibration, it is possible to know whether there are superposed reflected signals. Therefore, when a feature difference value between the waveform feature of the preamble signals output from the receiver and the preset waveform feature exceeds the preset threshold after the secondary emergent laser is emitted in the current detection cycle, it indicates that indistinguishable reflected signals are superposed in the preamble signals, resulting in a significant change in the waveform feature of the preamble signals. It indicates that the receiver receives the reflected laser, and the moment of receiving the reflected laser is earlier than the first preset moment. The first preset moment is the time of flight of photons corresponding to the farthest distance in the near-field blind zone of the secondary emission detection cycle. For example, when the secondary emission detection cycle has a ranging scope of 2-20 m, 0-2 m is the near-field blind region of the secondary emission detection cycle. 2 m is the farthest distance at the near-field blind zone. The first preset moment is the time of the photons round trip between the LiDAR and the position of 2 m. When the moment of receiving the reflected laser is earlier than the first preset moment, the reflected signals and the preamble signals are superposed together and too close to be distinguished. When the moment of receiving the reflected laser is later than the first preset moment, the waveforms of the reflected signals and the preamble signals can be distinguished, i.e., the reflected signals and the preamble signals can be identified from the echo signals. The moment of receiving the reflected laser can be obtained by solving the sampling moment of the reflected signal. Then, a distance can be calculated.

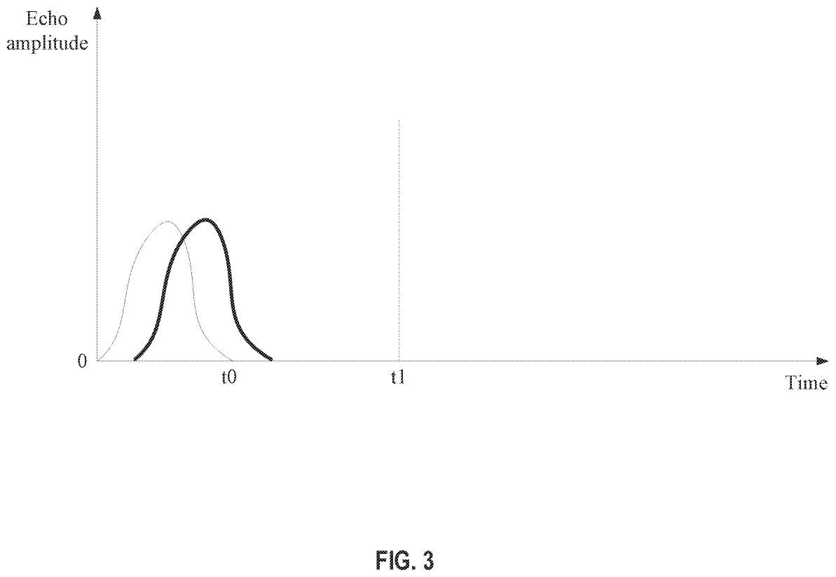

In some embodiments, the first preset moment is the quenching moment of the preamble signals in the secondary emission detection cycle. FIG. 3 shows a schematic diagram of the relationship between the reflected signals and the preamble signals. In some embodiments, the moment of receiving the reflected signals is earlier than the first preset moment. A thicker curve in FIG. 3 is the reflected signals. A thinner curve is the preamble signals. t₀ indicates the quenching moment of the preamble signals. From the waveform, it can be seen that the reflected signals are partially or completely superposed with the preamble signals, indicating that such waveform feature make it difficult for the output circuit of the back terminal to distinguish the waveforms of the two signals. The reflected signals cannot be identified so that the target object within the near-field range (before the moment t₀) cannot be effectively detected. The near-field blind zone is formed.

When the feature difference value between the waveform feature of the preamble signals output from the receiver and the preset waveform feature does not exceed the preset threshold, it indicates that the received echo signals are the preamble signals. There is no reflected signals. Therefore, the reflected laser is not received. The waveform feature of the above embodiment can be a pulse width. In some embodiments, the preamble signals have a pulse width greater than the preset threshold. The waveform feature can also be an amplitude. In some embodiments, the amplitude of the preamble signals is greater than the preset threshold. The waveform feature can also be a waveform area. In some embodiments, the preamble signals have a waveform area larger than the preset threshold. The larger waveform area may be caused by changes in the amplitude and/or the pulse width.

Step S1023: when the reflected signals are identified, determining the detection result according to the moment of receiving the reflected laser.

As described above, when the output circuit of the back terminal can identify the reflected signals, it indicates that two waveforms can be sampled in the secondary emission analysis region, which are the preamble signals and the reflected signals of the secondary emergent laser. The moment of receiving the reflected laser is obtained according to the sampling time of the reflected signals.

When the moment of receiving the reflected laser is less than a second preset moment, it is determined that the moment of receiving the reflected laser is earlier than the second preset moment, where the second preset moment is greater than the first preset moment. When the moment of receiving the reflected laser is greater than or equal to the second preset moment, it is determined that the moment of receiving the reflected laser is later than the second preset moment. In some embodiments, the second preset moment is the quenching moment of the preamble signals when a far-range mode is used for the primary emission detection cycle, i.e., the quenching moment of the preamble signals of the primary emergent laser.

It can be seen from the foregoing that the emission power of the primary emergent laser of the far-range mode is greater than that of the secondary emergent laser. Therefore, the quenching moment of the preamble signals of the primary emergent laser is later than that of the preamble signals of the secondary emergent laser, i.e., the second preset moment is greater than the first preset moment. In addition, the output circuit of the back terminal can identify the reflected signals, indicating that the target object is not within the near-field blind zone of the secondary emission detection cycle, i.e., the sampling time of the reflected signals is greater than the first preset time.

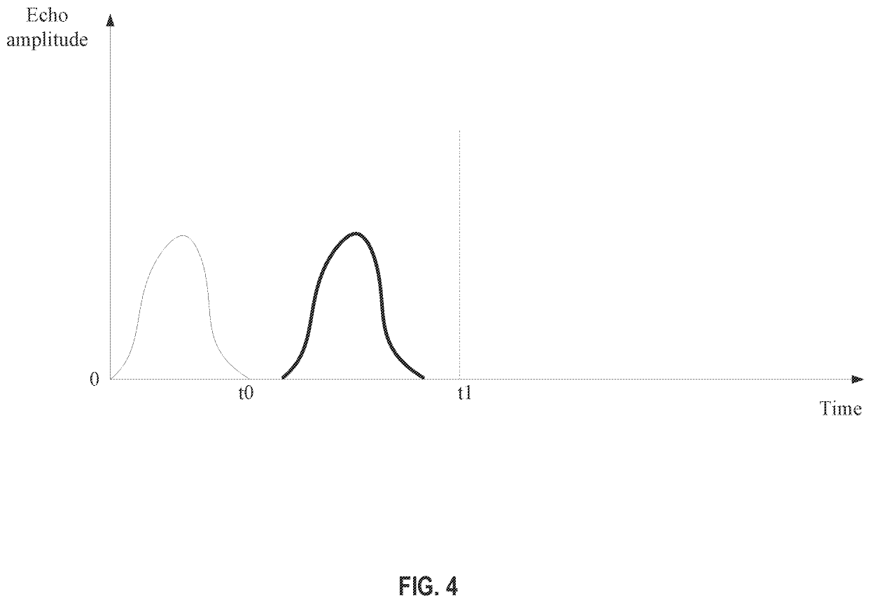

When the moment of receiving the reflected laser is less than the second preset moment, the moment of receiving the reflected laser is between the first preset moment and the second preset moment. The waveform of the reflected laser is shown in FIG. 4. The thicker curve in FIG. 4 is the reflected signals of the secondary emergent laser. The thinner curve is the preamble signals of the secondary emergent laser. t₁ in the figure indicates the quenching moment of the leading signal of the primary emergent laser (not shown in the figure) in the far-range mode, i.e., the second preset moment, while t₀ indicates the quenching moment of the preamble signals of the secondary emergent laser, i.e., the first preset moment. The moment of receiving the reflected laser of the secondary emergent laser is located between t₀ and t₁. The reflected signals are not superposed with the preamble signals of the secondary emergent laser, but are still superposed with the preamble signals of the primary emergent laser in the far-range mode. Therefore, the target object is located within the near-field blind zone in the main emission detection cycle of the far-range mode, e.g., the near-field blind zone in the main emission detection cycle of the far-range mode is 0-15 m.

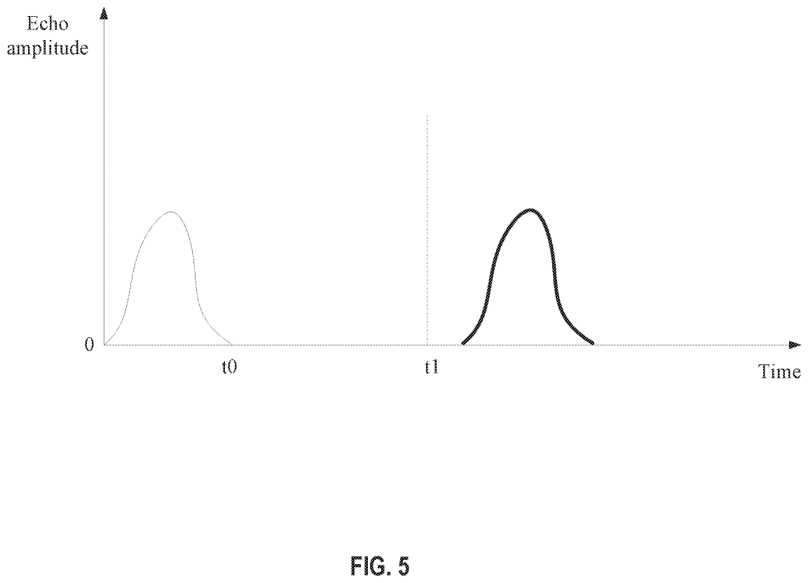

When the moment of receiving the reflected laser is larger than the second preset moment, the waveform of the reflected laser is shown in FIG. 5. The thicker curve in FIG. is the reflected signals of the secondary emergent laser. The thinner curve is the preamble signals of the secondary emergent laser, both t₁ and t₀ in the figure are described before. The moment of receiving the reflected laser of the secondary emergent laser is larger than t₁. The reflected signals are not superposed with the preamble signals of the secondary emergent laser or are not superposed with the preamble signals of the primary emergent laser of the far-range mode (not shown in the figure). As a result, the target object is located in the far-field region, e.g., the target region is located in the far-field region in a range of 15-200 m.

Step S103: determining the operation mode of the primary emergent laser in the next detection cycle according to the detection result obtained in step S102.

Four detection results can be obtained according to step S102 as follows.
(1) The reflected signals cannot be identified. The reflected signals are superposed with the preamble signals. The moment of receiving the reflected laser is less than t₀.
(2) The reflected signals cannot be identified. The reflected laser is not received.
(3) The reflected signals can be identified. The moment of receiving the reflected laser is less than t₁;
(4) The reflected signals can be identified. The moment of receiving the reflected laser is greater than t₂.

According to these four detection results, the distance distribution of the target objects in the detection region of the LiDAR can be roughly determined. Then, the operation mode of the primary emergent laser can be determined for further detection.

As one embodiment of the present application, according to the above detection result (1) obtained in step S102, the operation mode of the primary emergent laser in the next detection cycle can be determined as follows: when the moment of receiving the reflected laser is earlier than the first preset moment, the primary emergent laser in the next detection cycle is determined to adopt a close-range mode.

As can be seen from the foregoing, the detection result (1) indicates that the moment of receiving the reflected laser is less than t₀. It is indicated that the target object is located in the near-field blind region of the secondary emergent laser. The target object is very close to the LiDAR. For example, the secondary emergent laser has a ranging distance of 2-20 m. The target object is located in a range of 0-2 m. To be able to accurately detect the target object at a closer distance, the main emergent laser has emission power less than that of the secondary emergent laser. The stray light is further reduced. A small amount of the stray light does not excite the receiver. The receiver does not output the preamble signals, thus avoiding the impact of the preamble signals on the near-field detection, and being able to accurately detect the target object in the range of 0-2 m. Therefore, the primary emergent laser adopts the close-range mode. The primary emergent laser in the close-range mode has the emission power less than that of the secondary emergent laser. For example, the primary emergent laser in the close-range mode has a detection range of 0-10 m.

In some embodiments, according to the forgoing detection results (2) obtained in step S102, the operation mode of the primary emergent laser in the next detection cycle can be determined as follows: when it is determined that no reflected laser is received, it is determined that the primary emergent laser in the next detection cycle adopts the far-range mode.

It can be seen from the foregoing that, the detection result (2) indicates that there is no target object within the detection range of the secondary emergent laser, i.e., there is really no target object in the detection region of the LiDAR or the distance of the target object is larger than the detection range of the secondary emergent laser. There is also another case that the receiver cannot receive the reflected laser. Although there is a target object in the detection range of the secondary emergent laser, the returned reflected laser is very weak after the secondary emergent laser hits the low-reflectivity object, because the target object is a low-reflectivity object. The receiver cannot respond. The receiver cannot output the reflected signals. Therefore, the primary emergent laser adopts the far-range mode in the next detection cycle to obtain the strongest detection capability for further detection of the target object or the low-reflectivity object at a longer distance. The emission power of the primary emergent laser in the far-range mode is much larger than that of the secondary emergent laser, for example, the primary emergent laser in the far-range mode has a detection range of 15-200 m. Generally speaking, the emission power of the primary emergent laser in the far-range mode is the maximum emission power of the LiDAR, which is usually full power.

In addition, the detection result of the secondary emergent laser shows that when there is no reflected laser in the near-field region, such as a range of 2-20 m, the possibility that a person is within that distance can be ruled out. The next detection cycle adopts the primary emergent laser in the long-range mode, which can ensure the ranging capability of the LiDAR (for example, the farthest detection distance of the LiDAR needs to reach 200 m), and also ensure the safety of human eyes, thereby avoiding emitting the emergent laser with the high power when a person is in the near-field region.

In some embodiments, according to the detection result (3) obtained in step S102, the operation mode of the primary emergent laser in the next detection cycle can be determined as follows: when the moment of receiving the reflected laser is earlier than the second preset moment, the primary emergent laser in the next detection cycle is determined to adopt the close-range mode.

As can be seen from the foregoing, the detection result (3) indicates that there is a target object within the detection range of the secondary emergent laser. The target object is located within the near-field blind zone of the primary emergent laser in the far-range mode. The primary emergent laser in the far-range mode cannot effectively detect the target object, while the primary emergent laser in the close-range mode has sufficient emergent power to reliably detect the target object. Therefore, on the premise of satisfying detection demand, to avoid an unnecessary high power emission gear and reduce the overall power consumption of the LiDAR, it is determined that the primary emergent laser in the next detection cycle adopts the close-range mode. The emergent power of the primary emergent laser in the close-range mode is similar to the previous description.

In some embodiments, according to the detection result (3) obtained in step S102, the operation mode of the primary emergent laser in the next detection cycle can be determined as follows: when the moment of receiving the reflected laser is later than the second preset moment, the primary emergent laser in the next detection cycle is determined to adopt the far-range mode.

As can be seen from the foregoing, the detection result (4) indicates that there is a target object within the detection range of the secondary emergent laser. The target object is also located within the detection range of the primary emergent laser in the far-range mode. Therefore, for further detection and to ensure the overall ranging capability of the LiDAR, it is determined that the primary emergent laser in the next detection cycle adopts the far-range mode.

In addition, the emergent laser of the LiDAR scans the entire field of view to obtain one frame of complete data. A cycle to obtain one frame of the complete data is defined as a frame cycle. A frame cycle includes a plurality of detection cycles. Considering the safety of human eyes and to avoid the damage of a high-power laser to the human eyes, the operation mode of the primary emergent laser can be set as the close-range mode in an initial detection cycle of the forgoing frame cycle. Because the last detection period of the previous frame cycle corresponds to one end of the field of view, and the initial detection period of the next frame cycle corresponds to the other end of the field of view, it is not possible to accurately determine whether there is a person in the field of view corresponding to the current cycle by using the detection result of the secondary emergent laser of the previous detection cycle to determine the operation mode of the primary emergent laser. To ensure the safety of the human eyes, the primary emergent laser in the initial detection cycle uniformly adopts the close-range mode.

Step S104: emitting the primary emergent laser in the next detection cycle according to the operation mode of the primary emergent laser in the next detection cycle.

In some embodiments: when the operation mode of the primary emergent laser in the next detection cycle is the primary close mode, that is, the primary emergent laser adopts the close-range mode, the primary emergent laser in the next detection cycle adopts the close-range mode to emit the laser. When the operation mode of the primary emergent laser in the next detection cycle is the primary far mode, that is, the primary emergent laser adopts the far-range mode, the primary emergent laser in the next detection cycle adopts the far-range mode to emit the laser.

It should be noted that steps 103 and 104 can also be as follows.

Step S103′: determining the operation mode of the primary emergent laser in the current detection cycle according to the detection result obtained in step S102.

Step S104′: emitting the primary emergent laser in the current detection cycle according to the operation mode of the primary emergent laser in the current detection cycle.

When adopting a high-voltage constant-voltage source, the drive circuit of the laser device of the LiDAR can quickly respond and adjust the emission power of the laser device. According to the detection result of the secondary emergent laser in the current detection cycle, the operation mode of the primary emergent laser is determined. Response drive instructions are sent to the driver circuit. The driver circuit can quickly respond and directly drive the laser device to emit the primary emergent laser of the corresponding power.

However, to control input power, the LiDAR usually adopts drive circuits of the charging energy, transferring energy, and enabling energy to drive the laser device. When driving the laser device, a power source first charges a charging module and stores electrical energy on an inductor. After the charging energy is completed, the electrical energy stored on the inductor is transferred to an energy storage capacitor according to transferring energy instructions. Finally, the electrical energy stored on the energy storage capacitor is released to the laser device according to enabling instructions of the emission. The laser device emits. Therefore, the forgoing drive process takes some time. At the same time, after receiving the echo laser of the secondary emergent laser, the receiver outputs the echo signals. The output circuit of the back terminal amplifies, shapes, and samples the echo signals, which also takes some time. The detection result cannot be immediately output. Therefore, to ensure a point frequency of the LiDAR, this solution adopts the detection result of the secondary emergent laser in the current detection cycle to determine the operation mode of the primary emergent laser in the next detection cycle. When the driving speed of the laser device and the processing speed of the output circuit of the back terminal can be increased, forgoing steps S103′ and S104′ can also be adopted.

From the method for the laser detection exemplified in FIG. 1 above, it can be seen that the secondary emergent laser is emitted first in the detection cycle for detection. The operation mode of the primary emergent laser in the next detection cycle is determined according to the detection result of the secondary emergent laser. The secondary emergent laser has low emission power and can detect the near-field region first. According to the detection result in the near-field region, the distribution of the target object in the near-field region can be initially known. Then, the operation mode of the primary emergent laser can be determined. When the target objects are distributed in a farther region, the emission power of the primary emergent laser is increased to ensure the detection capability of the LiDAR. When the target objects are distributed in a nearer region, the emission power of the primary emergent laser is reduced to reduce a near-field blind zone generated by the stray light and avoid the unnecessary high-power emission gear, thus reducing the power consumption of the LiDAR product and improving the safety of human eyes.

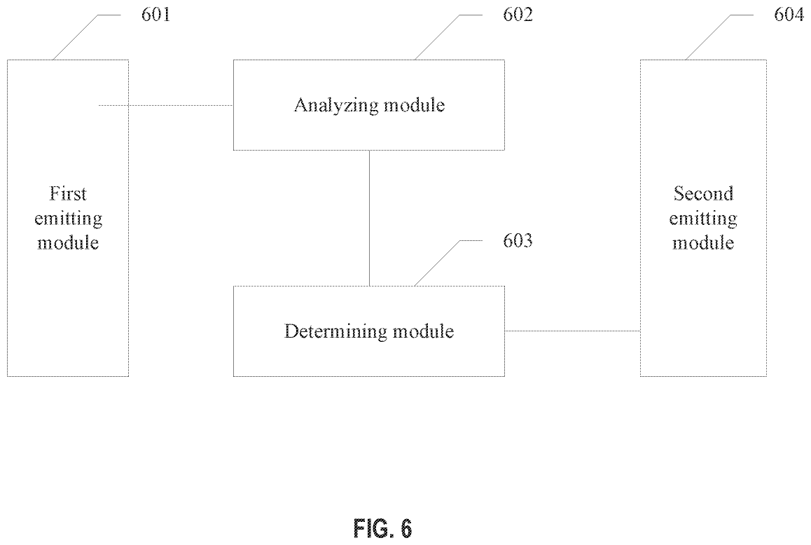

FIG. 6 is a schematic structural diagram of a device for laser detection shown in an embodiment of the present application. For ease of illustration, only those portions that relate to the embodiment of the present application are shown. The device for the laser detection exemplified in FIG. 6 mainly includes a first emitting module 601, an analyzing module 602, a determining module 603, and a second emitting module 604.

The first emitting module 601 is configured to emit a secondary emergent laser at a current moment of a detection cycle.

The analyzing module 602 is configured to receive and analyze an echo laser corresponding to the secondary emergent laser to obtain a detection result.

The determining module 603 is configured to determine an operation mode of a primary emergent laser in a next detection cycle according to the detection result.

The second emitting module 604 is configured to emit the primary emergent laser in the next detection cycle according to the operation mode of the primary emergent laser in the next detection cycle.

For the device in this embodiment, how the modules implement the operations has been described in the embodiments of the method in detail, and no further elaboration is provided herein.

From the device for the laser detection exemplified in FIG. 6 above, it can be seen that the secondary emergent laser is emitted first in the detection cycle for detection. The operation mode of the primary emergent laser in the next detection cycle is determined according to the detection result of the secondary emergent laser. The secondary emergent laser has low emission power and can detect a near-field region first. According to the detection result in the near-field region, the distribution of target objects in the near-field region can be initially known, and then the operation mode of the primary emergent laser can be determined. When the target objects are distributed in a farther region, the emission power of the primary emergent laser is increased to ensure the detection capability of a LiDAR product. When the target objects are distributed in a nearer region, the emission power of the primary emergent laser is reduced to reduce a near-field blind zone generated by stray light and avoid an unnecessary high-power emission gear, thus reducing the power consumption of a LiDAR product and improving the safety of human eyes.

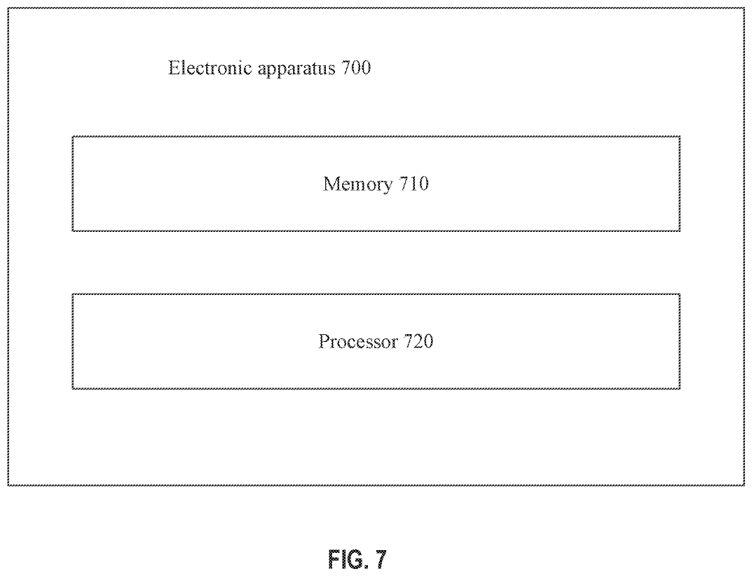

FIG. 7 is a schematic structural diagram of an electronic apparatus shown in an embodiment of the present application.

Referring to FIG. 7, the electronic apparatus 700 includes a memory 710 and a processor 720.

The processor 720 can be a Central Processing Unit (CPU) or other general-purpose processor, Digital Signal Processor (DSP), Application Specific Integrated Circuit (ASIC), Field-Programmable Gate Array (FPGA), or other programmable logic device, a discrete gate or transistor logic device, a discrete hardware component, etc. The general-purpose processor can be a microprocessor, or the processor can be any conventional processor or the like.

The memory 710 can include various types of storage units, such as a system memory, a read-only memory (ROM), and a permanent storage device. The ROM can store static data or instructions needed by the processor 720 or other modules of a computer. The permanent storage device can be a readable/writable storage device. The permanent storage device can be a non-volatile storage device that does not lose stored instructions and data even when a computer is powered off. In some embodiments, the permanent storage device uses a large-capacity storage device (for example, a magnetic or optical disk, or a flash memory). In some other embodiments, the permanent storage device can be a removable storage device (for example, a floppy disk or a CD-ROM drive). A system memory can be a readable/writable storage device or a volatile readable/writable storage device, for example, a dynamic random access memory. The system memory can store some or all of instructions and data required by the processor during running. In addition, the memory 710 can include any combination of computer-readable storage media, including various types of semiconductor memory chips (e.g., DRAM, SRAM, SDRAM, flash memory, and programmable read-only memory). A disk and/or the optical disk can also be employed. In some embodiments, the memory 710 can include a readable/writable removable storage device such as a compact disc (CDs), a read-only digital versatile disk (e.g., DVD-ROM, a dual-layer DVD-ROM), a read-only Blue-ray disk, an ultra-dense disk, a flash memory card (e.g., an SD card, a min SD card, a micro-SD card, etc.), a magnetic floppy disk, etc. The computer-readable storage medium does not include a carrier wave or transient electronic signals transmitted wirelessly or by wire.

Executable codes are stored on the memory 710. When processed by the processor 720, the executable codes can cause the processor 720 to execute some or all of the methods described above.

In addition, the method according to the present application can also be implemented as a computer program or a computer program product, where the computer program or the computer program product includes computer program code instructions for executing some or all of the steps in the forgoing method in the present application.

In some embodiments, the present application can be implemented as a computer-readable storage medium (or a non-transitory machine-readable storage medium or a machine-readable storage medium) having executable codes stored thereon (or the computer program or computer instruction codes). When executed by the processor (a server, or the like) of the electronic apparatus, the executable codes (or the computer program or the computer instruction codes) cause the processor to execute some or all of the steps in the forgoing method in the present application.

The embodiments of the present application are described above, but the above description is exemplary other than exhaustive, and is not limited to the disclosed embodiments. Various modifications and alterations shall be evident to a person skilled in the art without departing from the scope and spirit of the described embodiments. The terms used herein are intended to optimally explain the principle of each embodiment, actual application or improvement of technologies in the art, or help other a person skilled in the art understand the embodiments disclosed herein.

What is claimed is:

1. A method for laser detection, comprising:
emitting a secondary emergent laser in a current detection cycle;
receiving and analyzing an echo laser corresponding to the secondary emergent laser to obtain a detection result;
determining an operation mode of a primary emergent laser in a next detection cycle according to the detection result; and
emitting the primary emergent laser in the next detection cycle according to the operation mode.

2. The method according to claim 1, wherein receiving and analyzing the echo laser corresponding to the secondary emergent laser to obtain the detection result comprises:
determining whether reflected signals in echo signals are identified, the echo signals being electrical signals output by a receiver after the echo laser is received, the reflected signals being electrical signals output by the receiver after a reflected laser is received, the reflected laser being a returned laser which is the secondary emergent laser reflected by a target object;
when the reflected signals are not identified, determining the detection result according to a waveform feature of preamble signals of the secondary emergent laser; and
when the reflected signals are identified, determining the detection result according to a moment of receiving the reflected laser.

3. The method according to claim 2, wherein determining the detection result according to the waveform feature of the preamble signals of the secondary emergent laser comprises:
obtaining a feature difference value between the waveform feature of the preamble signals and a preset waveform feature, and comparing the feature difference value with a preset threshold;
when an absolute value of the feature difference value exceeds the preset threshold, determining that the moment of receiving the reflected laser is earlier than a first preset moment; and
when the absolute value of the feature difference value is less than or equal to the preset threshold, determining that the reflected laser is not received.

4. The method according to claim 3, wherein determining the operation mode of the primary emergent laser in the next detection cycle according to the detection result comprises:
when the moment of receiving the reflected laser is earlier than the first preset moment, determining that the primary emergent laser in the next detection cycle adopts a close-range mode.

5. The method according to claim 3, wherein determining the operation mode of the primary emergent laser in the next detection cycle according to the detection result comprises:
when it is determined that the reflected laser is not received, determining that the primary emergent laser in the next detection cycle adopts a far-range mode.

6. The method according to claim 2, wherein determining the detection result according to the moment of receiving the reflected laser comprises:
when the moment of receiving the reflected laser is less than a second preset moment, determining that the moment of receiving the reflected laser is earlier than the second preset moment, and the second preset moment being greater than a first preset moment; and
when the moment of receiving the reflected laser is greater than or equal to the second preset moment, determining that the moment of receiving the reflected laser is later than the second preset moment.

7. The method according to claim 6, wherein determining the operation mode of the primary emergent laser in the next detection cycle according to the detection result comprises:
when the moment of receiving the reflected laser is earlier than the second preset moment, determining that the primary emergent laser in the next detection cycle adopts a close-range mode.

8. The method according to claim 6, wherein determining the operation mode of the primary emergent laser in the next detection cycle according to the detection result comprises:
when the moment of receiving the reflected laser is later than the second preset moment, determining that the primary emergent laser in the next detection cycle adopts a far-range mode.

9. The method according to claim 1, wherein a frame cycle of an emergent laser comprise at least two detection cycles, and an operation mode of a primary emergent laser in an initial detection cycle in the frame cycle adopts a close-range mode.

10. A device for laser detection, comprising:
a first emitting module, configured to emit a secondary emergent laser at a current moment of a detection cycle;
an analyzing module, configured to receive and analyze an echo laser corresponding to the secondary emergent laser to obtain a detection result;
a determining module, configured to determine an operation mode of a primary emergent laser in a next detection cycle according to the detection result; and
a second emitting module, configured to emit the primary emergent laser in the next detection cycle according to the operation mode.

11. A non-transitory computer-readable storage medium having executable codes stored thereon, wherein when executed by a processor of an electronic device, the executable codes cause the processor to execute a method for laser detection, wherein the method comprises:
emitting a secondary emergent laser in a current detection cycle;
receiving and analyzing an echo laser corresponding to the secondary emergent laser to obtain a detection result;
determining an operation mode of a primary emergent laser in a next detection cycle according to the detection result; and
emitting the primary emergent laser in the next detection cycle according to the operation mode.
